(19) United States
(12) Patent Application Publication
(10) Pub. No.: US 2006/0132927 A1
(43) Pub. Date: Jun. 22, 2006

(54) Electrowetting chromatophore

(76) Inventor: Frank Changsoo Yoon, Newark, DE (US)

Correspondence Address: FRANK C. YOON, 8 JARRELL FARMS DRIVE, NEWARK, DE, 19711-3063, US

(21) Appl. No.: 11/290,970

(22) Filed: Nov. 30, 2005

Related U.S. Application Data
(60) Provisional application No. 60/631,931, filed on Nov. 30, 2004.

(51) Int. Cl. G02B 3/12

(52) U.S. Cl. 359/665

(57) ABSTRACT

A biomimetic optical stack that operates on the basis of electrowetting. The stack is comprised of several layers of solid and liquid materials sandwiched together to form a single hermetic panel. The first layer in the stack is a dielectric (10). The second layer in the stack is an electrode (12). The third layer in the stack is a discriminator (14). The fourth layer in the stack is an electrode (20) that is spaced apart from discriminator (14). The space between discriminator (14) and electrode (20) is filled with an anterior liquid (16) and a posterior liquid (18) that are immiscible. Liquid (16) is composed of an insulating fluid that exhibits a stronger affinity for the surface of discriminator (14) than does liquid (18). Liquid (18) is composed of a conducting fluid that exhibits a stronger affinity for the surface of electrode (20) than does liquid (16). The final layer in the stack is a dielectric (26).

### CROSS-REFERENCE TO RELATED APPLICATIONS

This application claims the benefit of provisional patent application No. 60/631,931, filed 2004 Nov. 30.

### BACKGROUND

1. Field of Invention

This invention relates to electronic devices, specifically to such devices that are used for modulating photons.

2. Description of Prior Art

The liquid crystal display (LCD) has served as the premier flat panel display technology for several decades. LCDs:
can be reflective; CRTs, PDPs, LEDs, and OLEDs are emissive.
have rapid response times; electrochromic and electrophoretic technologies have slower response times.
are thin and lightweight; CRTs and PDPs are thicker and heavier.

LCDs rely on polarizing filters, however, and typically transmit less than half the light passed through them. The polarizing filters also cause LCDs to have low contrast ratios, restricted viewing angles, and shifting colors.

The digital micromirror device (DMD) was recently developed to overcome some of the disadvantages of the LCD. DMDs use tilting mirrors to modulate reflected light and thus do not require polarizing filters. DMDs are not transparent, though, so they cannot be used as direct view displays.

The transition-metal switchable mirror (TMSM) is an emerging technology that offers a solid-state alternative to the DMD. TMSMs, particularly gasochromic ones, currently suffer from bulkiness and slow switching speeds, though, and remain untested by the commercial marketplace.

Objects and Advantages

Accordingly, besides the objects and advantages of the light modulators described in my above patent, several objects and advantages of the present invention are:
(a) to provide a window whose transparency, translucency, reflectivity, or tint, or any combination thereof, can be rapidly adjusted;
(b) to provide a surface whose diffusivity, reflectivity, or color, or any combination thereof, can be rapidly adjusted;
(c) to provide a display that can be backlit, reflective, transreflective, or projective;
(d) to provide a display that is brighter than those using liquid crystal technologies;
(e) to provide a display with a darker black level than those using liquid crystal technologies;
(f) to provide a display with a higher contrast ratio than those using liquid crystal technologies;
(g) to provide a display with a wider viewing angle than those using liquid crystal technologies; and
(h) to provide a display with a longer lifespan than those using liquid crystal technologies.

Henceforth, I shall describe windows, surfaces, and displays comprised of electrowetting chromatophores as being electrowetting or, if the chromatophores are composed of liquid metal, electroreflecting. Further objects and advantages are to provide an electroreflecting optical stack with a spectral response and dynamic range comparable to that of recently developed transition-metal switchable mirrors. Being a capacitance-based device, an electroreflecting optical stack should also be able to switch more quickly, efficiently, and reliably than competing electrochromic devices. Still further objects and advantages of my invention will become apparent from a consideration of the drawings and ensuing description.

### DRAWING FIGURES

FIG. 1 shows an isometric sectional view of an electrowetting optical stack with normally expanded (NE) insulating chromatophores.

FIG. 2 shows an isometric sectional view of an electrowetting optical stack with normally expanded (NE) conducting chromatophores.

FIG. 3A shows a sectional view on line 3A-3A of FIG. 1 detailing the arrangement of wicks.

FIGS. 3B to 3C show some alternative arrangements for wicks.

FIGS. 4A to 4C show in section the operation of an electrowetting optical stack with normally expanded (NE) insulating chromatophores.

FIGS. 5A to 5C show in plan several modes of appearance for an electrowetting optical stack.

FIG. 6 shows an isometric sectional view of an electrowetting optical stack with normally contracted (NC) conducting chromatophores.

FIGS. 7A to 7C show in section the operation of an electrowetting optical stack with normally contracted (NC) conducting chromatophores.

### REFERENCE NUMERALS IN DRAWINGS

| | | | |
|---|---|---|---|
| 10 | anterior dielectric | 12 | anterior electrode |
| 14 | discriminator | 16 | anterior liquid |
| 18 | posterior liquid | 20 | posterior electrode |
| 22 | divider | 24 | wick |
| 26 | posterior dielectric | 28 | posterior discriminator |
| 30 | chromatophore | | |

Description

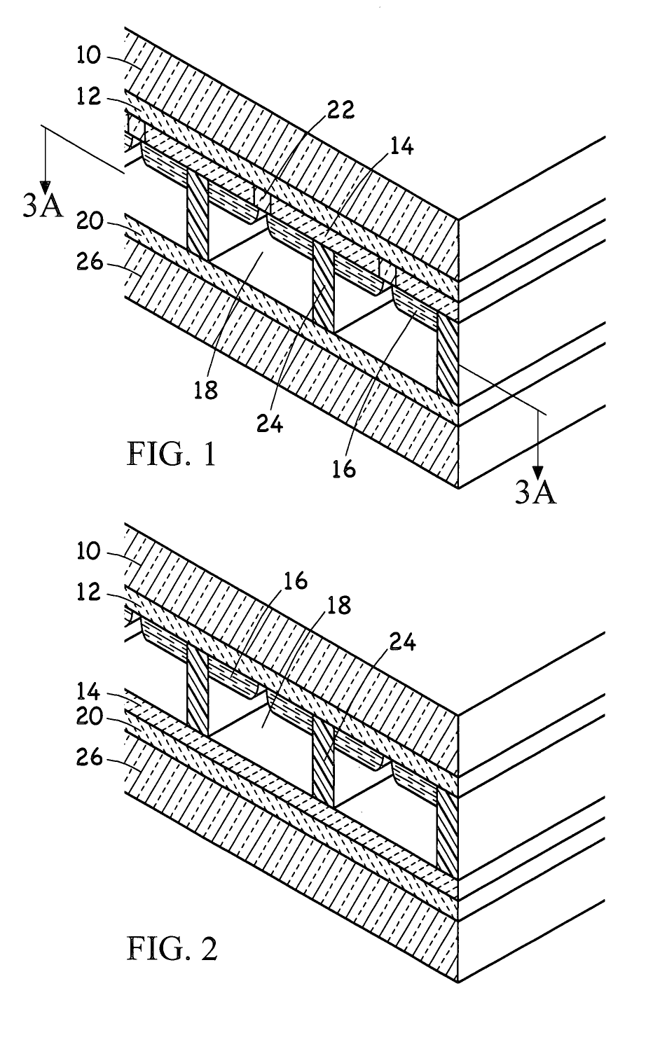

FIG. 1 shows an isometric sectional view of a basic electrowetting optical stack. The stack, which in this embodiment has normally expanded (NE) insulating chromatophores, consists of several layers of solid and liquid materials sandwiched together to form a single hermetic panel. Throughout this discussion, conducting should be understood to mean electrically conducting and insulating should be understood to mean electrically non-conducting.

The first or “anterior” layer in the stack is a dielectric 10 that is preferably composed of a transparent or translucent material, such as glass, crystal, plastic, etc. If anterior dielectric 10 is made of glass, it will typically be between 0.1 mm to 10 mm thick.

The second layer in the stack is an anterior electrode 12, which coats the posterior surface of dielectric 10. In the preferred embodiment, electrode 12 is composed of a transparent or translucent conductor, such as indium-tin-oxide (ITO), zinc oxide, or a conducting polymer. If electrode 12 is made of ITO, it will typically be between 100 angstroms to 2000 angstroms thick and have a surface resistance of 1 ohm to 100 ohms.

The third layer in the stack is a discriminator 14, which coats the posterior surface of electrode 12. Discriminator 14 is composed of a transparent or translucent, nonporous dielectric, which in the preferred embodiment is a hydrophobic material such as Cerablak™ metal phosphate coating available from Applied Thin Films, Inc.

The fourth layer in the stack is a nonporous posterior electrode 20 that is spaced apart from discriminator 14. For applications in which the stack must transmit light, electrode 20 will typically be composed of a transparent or translucent conductor, similar to that used in electrode 12. For applications in which the stack must specularly reflect light, electrode 20 will typically be composed of a lustrous metal, such as aluminum, silver, gold, etc. For applications in which the stack must absorb or diffusely reflect light, electrode 20 may be composed of a matte conductor, such as graphite.

The space between discriminator 14 and electrode 20 is filled with an anterior liquid 16 and a posterior liquid 18 that are immiscible and have similar densities. Liquid 16 is composed of an insulating fluid, such as an oil, a solvent, or distilled water, that exhibits a stronger affinity for the surface of discriminator 14 than does liquid 18. Liquid 18 is composed of a conducting fluid, such as a salt solution, an ionic liquid, or liquid metal, that exhibits a stronger affinity for the surface of electrode 20 than does liquid 16. Liquids 16 and 18 can be transparent, translucent, or opaque; colorless or tinted; clear, dyed, or colloidal. Each liquid can also contain surfactants that modify its miscibility and ability to wet surfaces.

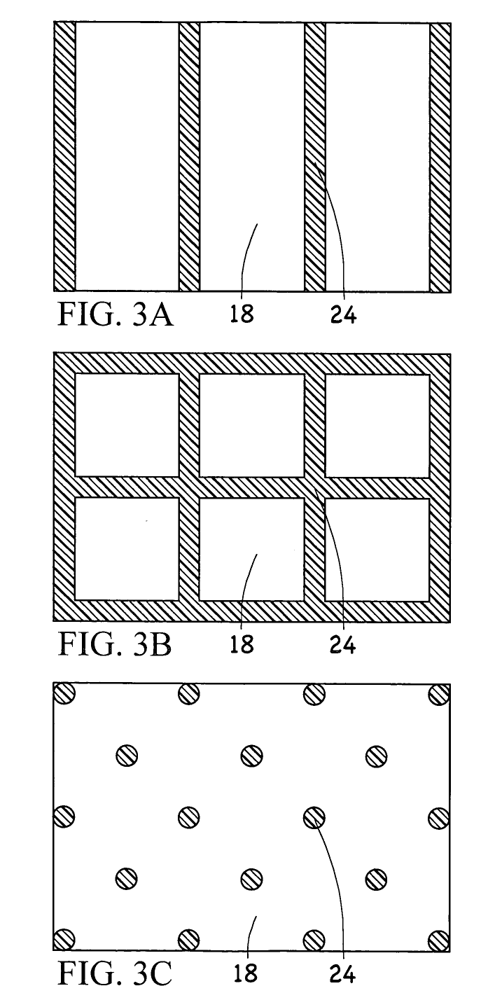

An optional array or network of wicks 24 spans the space between discriminator 14 and electrode 20. Wick 24 is composed of a dielectric whose surface exhibits a stronger affinity for liquid 16 than for liquid 18, but a weaker affinity for liquid 16 than does the surface of discriminator 14. In the preferred embodiment, wick 24 is composed of a hydrophobic material such as polytetrafluoroethylene (PTFE). Wick 24 can serve an ancillary function as a strut, pylon, support, or spacer between discriminator 14 and electrode 20. An array or network of wicks 24 can also serve to compartmentalize the space between discriminator 14 and electrode 20. FIG. 3A shows the arrangement of wicks 24 in the stack shown in FIG. 1. FIGS. 3B to 3C show two alternative arrangements for wicks 24.

An optional array or network of dividers 22, which typically run medially to wicks 24, separates discriminator 14 into regions that coincide with individual chromatophores. Divider 22 is composed of a nonporous dielectric whose surface exhibits a stronger affinity for liquid 18 than for liquid 16. The surface of divider 22 can be flush with that of discriminator 14, as shown in FIG. 1, or raised or recessed from it.

The fifth and final layer in the stack is a posterior dielectric 26, which can also serve as a substrate for electrode 20. For applications in which the stack must transmit light, dielectric 26 will typically be composed of a transparent or translucent material, similar to that used in dielectric 10. For applications in which the stack must absorb or diffusely reflect light, dielectric 26 will typically be composed of a matte material, such as titanium dioxide.

FIG. 2 shows an isometric sectional view of an electrowetting optical stack with normally expanded (NE) conducting chromatophores. This stack differs from the previously described basic stack with NE insulating chromatophores as follows:
Anterior electrode 12 is nonporous.
The third layer in the stack, which is discriminator 14, is spaced apart from electrode 12.
Anterior liquid 16 and posterior liquid 18, which are immiscible and have similar densities, fill the space between electrode 12 and discriminator 14. Liquid 16 is composed of a conducting fluid that exhibits a stronger affinity for the surface of electrode 12 than does liquid 18. Liquid 18 is composed of an insulating fluid that exhibits a stronger affinity for the surface of discriminator 14 than does liquid 16.
The optional array or network of wicks 24 spans the space between electrode 12 and discriminator 14. Wick 24 is composed of a dielectric whose surface exhibits a stronger affinity for liquid 16 than for liquid 18, but a weaker affinity for liquid 16 than does the surface of electrode 12.
Posterior electrode 20, which may be porous, can serve as a substrate for discriminator 14.

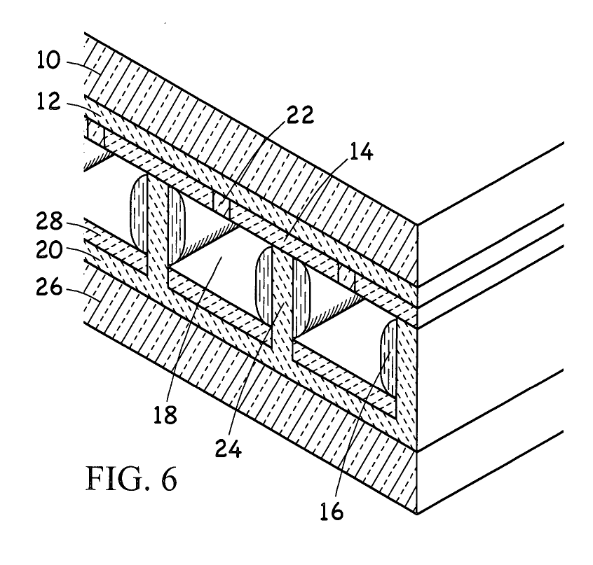

FIG. 6 shows an isometric sectional view of an electrowetting optical stack with normally contracted (NC) conducting chromatophores. This stack differs from the previously described basic stack with NE insulating chromatophores as follows:
Wick 24 is not optional and is composed of a conductor.
Posterior electrode 20 is electrically continuous with wicks 24.
A posterior discriminator 28 coats the anterior surface of electrode 20 between the array or network of wicks 24. Discriminator 28 is composed of materials similar to those used in discriminator 14.
Anterior liquid 16 and posterior liquid 18, which are immiscible and have similar densities, fill the space between discriminator 14 and discriminator 28. Liquid 16 is composed of a conducting fluid that exhibits a stronger affinity for the surface of wicks 24 than does liquid 18. Liquid 18 is composed of an insulating fluid that exhibits a stronger affinity for the surfaces of discriminators 14 and 28 than does liquid 16.
   Operation

The electrowetting optical stack with normally expanded (NE) insulating chromatophores shown in FIG. 1 operates as follows. For the purposes of this discussion, we will assume that liquid 16 is composed of an opaque black fluid, liquid 18 is composed of a colorless transparent fluid, dielectric 26 is backed by a matte white coating, and the remainder of the stack is composed of colorless transparent materials.

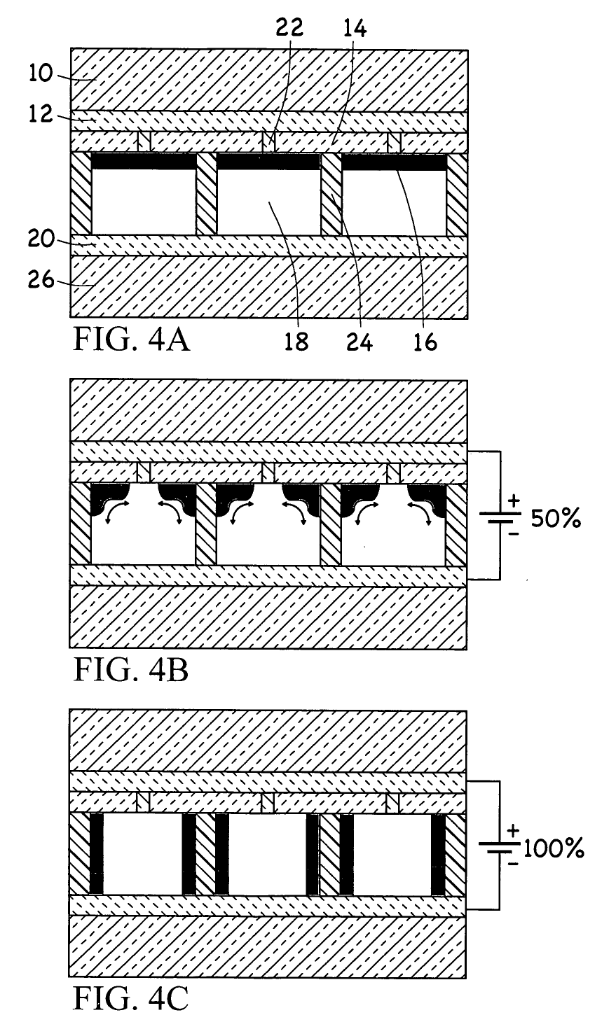

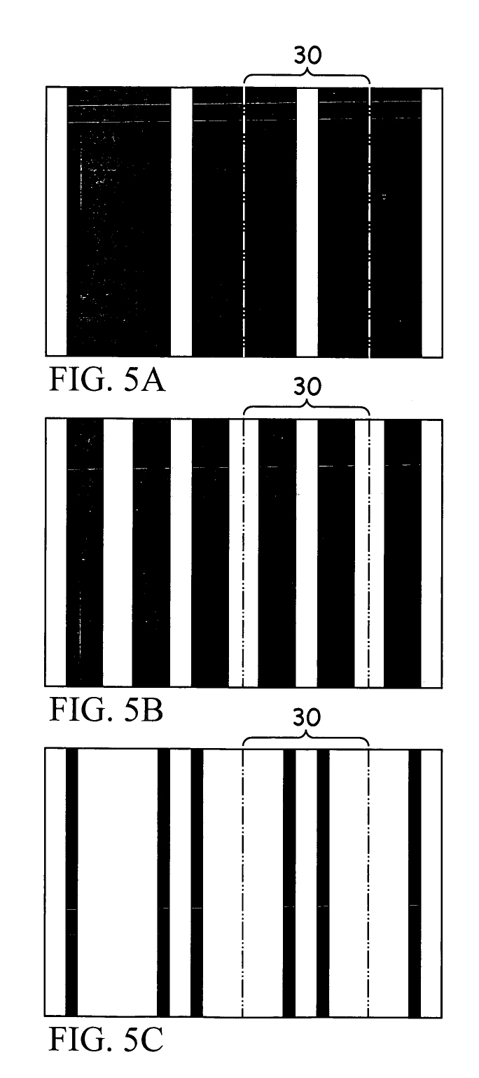

FIG. 4A shows that when no electric potential is applied between electrodes 12 and 20, liquid 16 will coat discriminator 14 to the exclusion of liquid 18. To an observer looking into the stack through dielectric 10, liquid 16 occults posterior liquid 18 and the stack will appear black (FIG. 5A).

FIG. 4B shows that when a moderate electric potential is applied between electrodes 12 and 20, liquid 18 will partially displace liquid 16 from the surface of discriminator 14; liquid 16 will part along dividers 22 and then slide down the sides of wicks 24. This use of an electric field to increase liquid 18's ability to “wet” the surface of discriminator 14 is called electrowetting. To an observer looking into the stack through dielectric 10, the stack will appear gray (FIG. 5B).

FIG. 4C shows that when some maximum electric potential is applied between electrodes 12 and 20, liquid 18 will completely displace liquid 16 from the surface of discriminator 14; liquid 16 will accumulate on the sides of wicks 24. To an observer looking into the stack through dielectric 10, the stack will appear white (FIG. 5C).

The electrowetting optical stack with normally expanded (NE) conducting chromatophores shown in FIG. 2 operates similarly to the stack with NE insulating chromatophores. The stack with NE conducting chromatophores, however, is comprised of an anterior liquid 16 that is conducting and a posterior liquid 18 that is insulating. When an electric potential is applied between electrodes 12 and 20, liquid 16 will remove itself from the surface of anterior electrode 12 and be replaced, not displaced, by liquid 18. The resulting change in the relative dispositions of liquid 16 and liquid 18, however, will be the same as before.

The electrowetting optical stack with normally contracted (NC) conducting chromatophores shown in FIG. 6 operates in an inverse manner to the stack with NE insulating chromatophores.

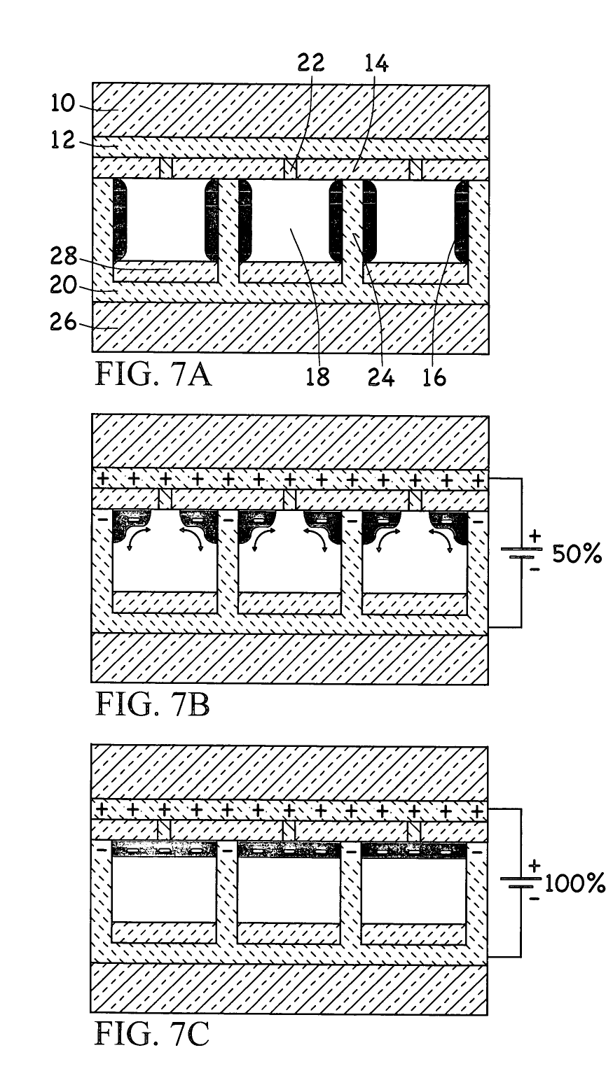

FIG. 7A shows that when no electric potential is applied between electrodes 12 and 20, liquid 18 will coat discriminators 14 and 28 to the exclusion of liquid 16; liquid 16 will accumulate on wicks 24. To an observer looking into the stack through dielectric 10, the stack will appear white (FIG. 5C).

FIG. 7B shows that when a moderate electric potential (shown here with an arbitrary polarity) is applied between electrodes 12 and 20, liquid 16 will partially displace liquid 18 from the surface of discriminator 14. To an observer looking into the stack through dielectric 10, the stack will appear gray (FIG. 5B).

FIG. 7C shows that when some maximum electric potential is applied between electrodes 12 and 20, liquid 16 will completely displace liquid 18 from the surface of discriminator 14. To an observer looking into the stack through dielectric 10, the stack will appear black (FIG. 5A).

As should be apparent from the description above, the chromatophores in an electrowetting optical stack are primarily comprised of anterior liquid 16. When liquid 16 occults liquid 18, a stack's chromatophores will appear to be expanded. When liquid 16 is beaded up or accumulated by a network or array of wicks 24, a stack's chromatophores will appear to be contracted. A typical chromatophore 30 is delineated in FIGS. 5A to 5C.

The optical properties of a stack depend on the composition of its constituent layers as well as the relative dispositions of liquids 16 and 18. Since each layer and liquid can be transparent, translucent, opaque, clear, or tinted, or some combination thereof, a stack can be constructed to display any one of a wide variety of optical transitions.

Ideally, a stack's chromatophores will be too small to be resolved at normal viewing distances with the naked eye. An array or network of dividers 22 is used to break liquid 16 up into chromatophores of predetermined size. An array or network of wicks 24 is used to perform a similar function. Coalescing points, which are regions on discriminator 14 that have a stronger affinity for liquid 16 than do the surrounding surfaces, can act as an alternative to wicks 24; the latter, however, will best minimize the size of contracted chromatophores. The distribution and size of a stack's chromatophores may be further refined through the addition of surfactants to liquids 16 and 18, the application of an oscillating electric potential between electrodes 12 and 20, or the propagation of ultrasonic vibrations through the stack.

Summary and Ramifications

Accordingly, the reader will see that the electrowetting chromatophore of this invention can be used to construct an electrowetting or electroreflecting window, surface, or display.

A pixel comprised of an array of electrowetting chromatophores can serve as the basis for an electrowetting display (EWD). A color pixel in such a display can consist of three superimposed transparent electrowetting optical stacks with NE insulating chromatophores; liquid 16 in each stack is dyed to absorb a unique subtractive primary color (yellow, magenta, cyan). An EWD comprised of such pixels can be backlit, reflective, transreflective, or projective.

If liquid 16 in an electrowetting optical stack is composed of a liquid metal, such as mercury, gallium, indium, etc., or an alloy thereof, the stack will be electroreflecting. A transparent electroreflecting optical stack with NC conducting chromatophores will transition from a window to a mirror upon the application of an electric potential.

A pixel comprised of an array of electroreflecting chromatophores can serve as the basis for an electroreflecting display (ERD). An ERD does not depend on moving mechanical parts to operate and can therefore be simpler, cheaper, and more reliable than a digital micromirror device (DMD) display. Other potential applications for electroreflecting chromatophores include electroreflecting windows that can instantly protect pilots, soldiers, and military optics from blinding laser radiation, electroreflecting architectural glass that can adjustably reflect sunlight from buildings, and electroreflecting surface panels that can help regulate the temperature of satellites.

Although the description above contains many specificities, these should not be construed as limiting the scope of the invention but as merely providing illustrations of some of the presently preferred embodiments of this invention. For example, the optical stack can be curved or cylindrical; either of the immiscible liquids could contain nanoparticles, etc.

Thus the scope of the invention should be determined by the appended claims and their legal equivalents, rather than by the examples given.

I claim:

1. An electrowetting optical stack, comprising:
(a) an anterior dielectric layer,
(b) an anterior electrode layer that coats the posterior surface of said anterior dielectric layer,
(c) a discriminator layer composed of a nonporous dielectric that coats the posterior surface of said anterior electrode layer,
(d) a posterior electrode layer that is spaced apart from said discriminator layer,
(e) an anterior liquid composed of an insulating fluid that partly fills the space between said discriminator layer and said posterior electrode layer,
(f) a posterior liquid composed of a conducting fluid that partly fills the space between said discriminator layer and said posterior electrode layer,
(g) said anterior liquid and said posterior liquid are immiscible,
(h) said anterior liquid exhibits a stronger affinity for the surface of said discriminator layer than does said posterior liquid,
(i) said posterior liquid exhibits a stronger affinity for the surface of said posterior electrode layer than does said anterior liquid,
(j) a posterior dielectric layer that coats the posterior surface of said posterior electrode layer.

2. The stack of claim 1, further including an array or network of dividers composed of a nonporous dielectric that replaces portions of the posterior surface of said discriminator layer, and whose surface exhibits a stronger affinity for said posterior liquid than for said anterior liquid.

3. The stack of claim 1, further including an array or network of wicks composed of a dielectric that spans the space between said discriminator layer and said posterior electrode layer, and whose surface exhibits a stronger affinity for said anterior liquid than for said posterior liquid but a weaker affinity for said anterior liquid than does the surface of said discriminator layer.

4. The stack of claim 1 wherein said posterior liquid is comprised of a liquid metal.

5. The stack of claim 1 wherein said posterior liquid is comprised of a liquid metal alloy.

6. The stack of claim 1 wherein said posterior liquid is comprised of an ionic liquid.

7. An electrowetting optical stack, comprising:
(a) an anterior dielectric layer,
(b) an anterior electrode layer composed of a nonporous conductor that coats the posterior surface of said anterior dielectric layer,
(c) a discriminator layer composed of a nonporous dielectric that is spaced apart from said anterior electrode layer,
(d) an anterior liquid composed of a conducting fluid that partly fills the space between said anterior electrode layer and said discriminator layer,
(e) a posterior liquid composed of an insulating fluid that partly fills the space between said anterior electrode layer and said discriminator layer,
(f) said anterior liquid and said posterior liquid are immiscible,
(g) said anterior liquid exhibits a stronger affinity for the surface of said anterior electrode than does said posterior liquid,
(h) said posterior liquid exhibits a stronger affinity for the surface of said discriminator layer than does said anterior liquid,
(i) a posterior electrode layer that coats the posterior surface of said discriminator layer,
(j) a posterior dielectric layer that coats the posterior surface of said posterior electrode layer.

8. The stack of claim 7, further including an array or network of wicks composed of a dielectric that spans the space between said anterior electrode layer and said discriminator layer, and whose surface exhibits a stronger affinity for said anterior liquid than for said posterior liquid but a weaker affinity for said anterior liquid than does the surface of said anterior electrode layer.

9. The stack of claim 7 wherein said anterior liquid is comprised of a liquid metal.

10. The stack of claim 7 wherein said anterior liquid is comprised of a liquid metal alloy.

11. The stack of claim 7 wherein said anterior liquid is comprised of an ionic liquid.

12. An electrowetting optical stack, comprising:
(a) an anterior dielectric layer,
(b) an anterior electrode layer that coats the posterior surface of said anterior dielectric layer,
(c) a discriminator layer composed of a nonporous dielectric that coats the posterior surface of said anterior electrode layer,
(d) a posterior electrode layer that is spaced apart from said discriminator layer,
(e) an array or network of wicks composed of a conductor that spans the space between said discriminator layer and said posterior electrode layer, and which is electrically continuous with the latter,
(f) a posterior discriminator composed of materials similar to those used in said discriminator that coats the anterior surface of said posterior electrode between the array or network of said wicks,
(g) an anterior liquid composed of a conducting fluid that partly fills the space between said discriminator layer and said posterior discriminator layer,
(h) a posterior liquid composed of an insulating fluid that partly fills the space between said discriminator layer and said posterior discriminator layer,
(i) said anterior liquid and said posterior liquid are immiscible,
(j) said anterior liquid exhibits a stronger affinity for the surface of said wicks than does said posterior liquid,
(k) said posterior liquid exhibits a stronger affinity for the surfaces of said discriminator layer and said posterior discriminator layer than does said anterior liquid,
(l) a posterior dielectric layer that coats the posterior surface of said posterior electrode layer.

13. The stack of claim 12, further including an array or network of dividers composed of a nonporous dielectric that replaces portions of the posterior surface of said discriminator layer, and whose surface exhibits a stronger affinity for said posterior liquid than for said anterior liquid.

14. The stack of claim 12 wherein said anterior liquid is comprised of a liquid metal.

15. The stack of claim 12 wherein said anterior liquid is comprised of a liquid metal alloy.

16. The stack of claim 12 wherein said anterior liquid is comprised of an ionic liquid.
